(19) United States
(12) Patent Application Publication
(10) Pub. No.: US 2013/0320659 A1
(43) Pub. Date: Dec. 5, 2013

(54) Bible/Book Tray

(71) Applicants: DeWayne Taylor, Princeton, WV (US); Chad Davidson, Princeton, WV (US)

(72) Inventors: DeWayne Taylor, Princeton, WV (US); Chad Davidson, Princeton, WV (US)

(21) Appl. No.: 12/981,662

(22) Filed: Mar. 17, 2011

(51) Int. Cl. B42D 17/00

(52) U.S. Cl. 281/45

(57) ABSTRACT

The Tray is a support for books that creates a horizontal space where one did not exist previously. By hooking it to a seat or rail in front of one, one can provide oneself with a sturdy support to allow hands-free reading. The Tray frees ones hands so that one may do other tasks like take notes, use reading aids, or hold small children.

### BACKGROUND OF THE INVENTION

The Bible/Book Tray (“Tray”) falls into the field of book holders. It is horizontal in design which allows for easier page turning unlike U.S. Pat. No. 4,369,948 to Krauss et al. (“Krauss”). Krauss is a vertical stand. The Tray utilizes a hook so it can be used on pews or seating in front of the user. U.S. Pat. No. 2,150,709 to Bake (“Bake”) also provides a hook, but Bake intended his/her invention to be used in a moving vehicle. This is not the intended use of the Tray.

### BRIEF SUMMARY OF THE INVENTION

The Tray's main focus is to support the Bible for reading purposes but can be used by other books and tablets as well as electronic reading devices. It supplies a horizontal space where one did not exist before. This space allows for hands free reading and helps those who need to use reading aids such as magnifying glasses. The Tray is even beneficial to people needing to hold small children.

### BRIEF DESCRIPTION OF THE SEVERAL VIEWS OF THE DRAWINGS

In FIG. 1A one can see that the Tray extends towards the user and horizontal to the ground.

FIG. 1B shows the hook that allows the Tray to remain stable.

FIG. 1C shows the adjustable tightening device which allows for use with different thicknesses of seating.

FIG. 1D shows an example of seating like a church pew or folding chair.

FIG. 1E displays the edge that stops the books from sliding off.

FIG. 2 is an overhead to show the Tray as a whole when attached to a church pew.

### DETAILED DESCRIPTION OF THE INVENTION

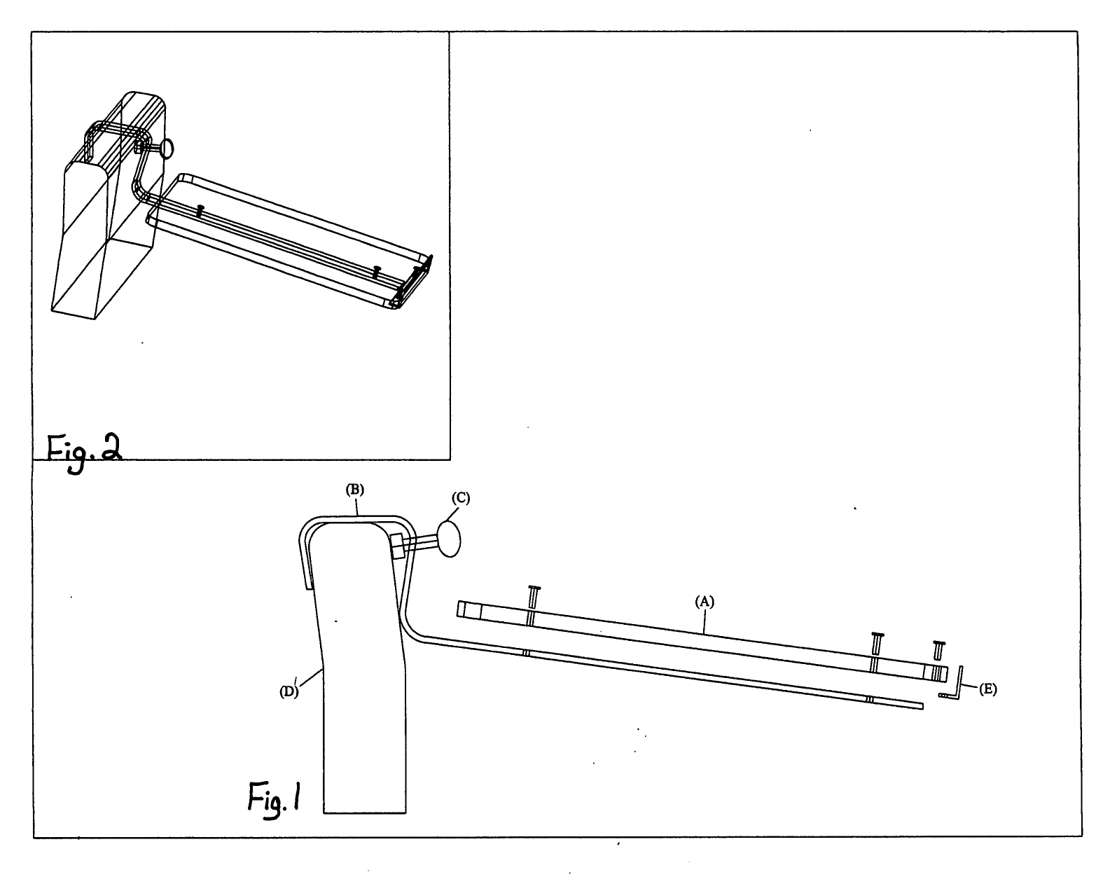

The Tray is a small light weight device that allows one to put their Bible on it and use their hands for other things. The Tray is only 14 inches in length total and weighs less than a pound. Its base is constructed of a strong but light weight material. In FIG. 2 one can see that the base is only about 10½ inches long and 7½ inches wide. This size is plenty of room for most all sizes of Bibles to fit on. FIG. 1E shows the bottom lip which keeps the Bible from sliding off. The size of the lip is 6 inches wide and is centered on the base bottom. The lip is ⅜ inch on the back side and ½ inch on the front side which is the catch side. FIG. 1B shows the support hook. The hook is 13¼ inches long and 1 inch wide and flat. It is made of strong light weight material and has a hook on the top end that allows it to attach to any standard seating as shown in FIG. 1D. It runs down the center of the base and stops 2 inches short of the bottom of the base as shown in FIG. 1A. The top side or hook side is arching in design and is where the tightening device is located as shown in FIG. 1C. The tightening device should be easy to use and easy to grip.

1. We claim that the tray will provide a horizontal support space where one did not previously exist: This space will free up the hands of the user so that they may do other task at the same time like take notes, hold reading aids, and even hold small children.
